(19) United States
(12) Patent Application Publication
(10) Pub. No.: US 2012/0193067 A1
(43) Pub. Date: Aug. 2, 2012

(54) VEHICLE ROOF DE-ICING SYSTEM

(76) Inventor: Christopher Miller, Quakertown, PA (US)

(21) Appl. No.: 13/014,905

(22) Filed: Jan. 27, 2011

(51) Int. Cl. B62D 53/00

(52) U.S. Cl. 165/41

(57) ABSTRACT

A roof heating system for opposing buildup of ice and snow on the roof of a large wheeled vehicle, such as a tractor drawn trailer. The system may comprise a fluid circulation system for transferring heat to the roof, including a first heat exchanger for obtaining heat from the exhaust system of the vehicle or alternatively, a tow vehicle, a second heat exchanger for delivering heat to the roof of the protected vehicle, and a powered system for circulating fluid from the first heat exchanger to the second heat exchanger. The system may comprise an electric motor driven pump to achieve circulation, a battery to power the electric motor of the pump, a recharging system for recharging the battery, and a switch to initiate system operation. The recharging system may be adapted to utilize AC power.

### FIELD OF THE INVENTION

The present invention relates to large wheeled vehicles, and more particularly to a heating system for heating the roof of a vehicle, to prevent buildup of ice and snow.

### BACKGROUND OF THE INVENTION

Large vehicles, such as tractor drawn trailers, trucks, and busses are widely used to transport goods and bulk commodities across the United States. Large vehicles are typically kept outdoors both when transporting goods or people and also when parked or in staging areas. There exists great potential for ice and snow to accumulate on the roofs of large vehicles in inclement weather.

While small incidental buildup of ice and snow seems to present little if any problem, there exists the possibility that significantly large and heavy sections of ice and snow will become dislodged and fall from the vehicle roof. This may present significant safety hazards, particularly at highway speeds, as falling pieces of ice and the like may strike the windshield of a nearby vehicle, may momentarily distract other drivers, or may even cause a hazardous condition in that the surface of the roadway may become littered with pieces of ice which might impede braking by other vehicles.

It is difficult at best for the operator of a large vehicle to monitor the roof for presence of ice and snow buildup. It is even more difficult to remove such ice and snow if detected, in vehicles wherein the roof surfaces are beyond convenient reach of a person on the ground or in the cabin of a tow vehicle.

There exists a need for a system which can be activated to minimize buildup of ice and snow on the roof of a large vehicle to overcome the hazard noted above.

### SUMMARY OF THE INVENTION

The present invention provides a system for removing ice from the roof of a large vehicle, such as a truck, bus, or tractor drawn trailer. The system provides a heated medium which is disposed in heat exchange relation to the roof of a large vehicle such that ice and snow formations can be melted before becoming so large as to present the hazard noted above.

The system may utilize a suitable fluid such as coolant comprising water combined with a freeze point depressant and boiling point extender, and may include a heat exchange arrangement to heat this fluid from waste engine heat. The source of waste engine heat may be the exhaust system of the tow vehicle.

The system may include a circulating pump adapted to circulate the coolant, to assure that enough of heat is present to accomplish the goals of the invention. The system may include a battery to power the circulating pump, recharging apparatus to recharge the battery, and a switch to initiate operation.

It is an object of the invention to provide a system for overcoming buildup of ice and snow on the roof of a large vehicle by heating the roof.

Another object of the invention is to utilize otherwise wasted heat from vehicle operation.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a side view of a tractor and trailer combination according to at least one aspect of the invention.

FIG. 2 is a top view of the tractor and trailer combination of FIG. 1.

FIG. 3 is a diagrammatic view of a fluid circulation circuit provided in the tractor and trailer combination of FIG. 1.

FIG. 4 is an electrical schematic showing electrical components for operating the fluid circulation circuit of FIG. 3.

FIG. 5 shows some optional electrical components which may be added to those depicted in FIG. 4.

FIG. 6 is an enlarged top detail view of a heat exchanger seen at the right of FIG. 3.

FIG. 7 is a front perspective view of an exemplary housing containing the components shown in FIG. 5 and also other components of a system including a fluid circulation circuit according to at least one aspect of the invention.

### DETAILED DESCRIPTION

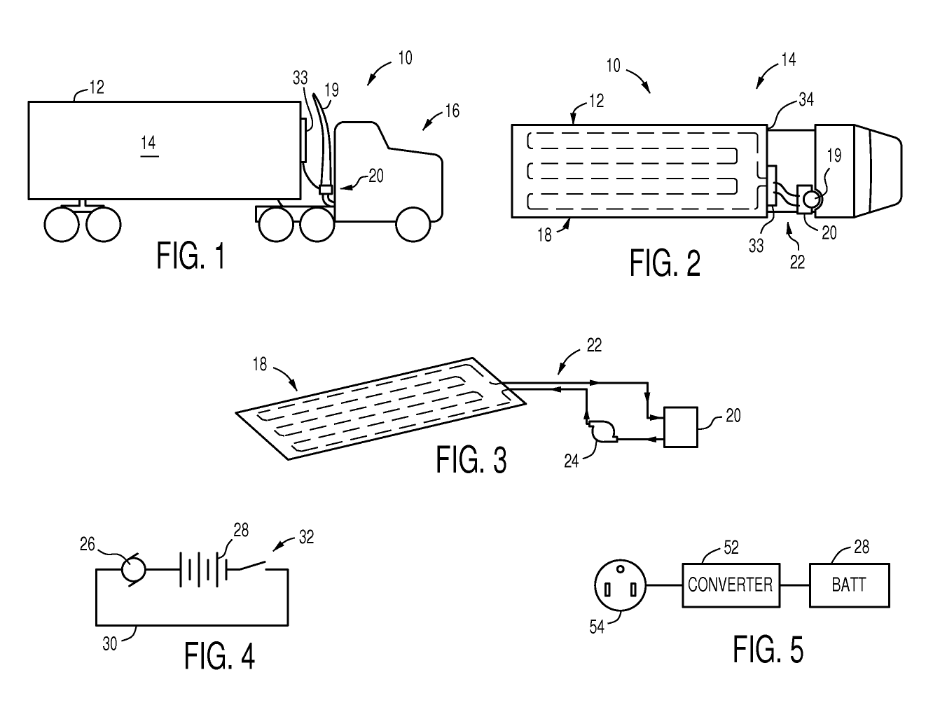

Referring first to FIG. 1, according to at least one aspect of the invention, there is seen a tractor and trailer combination 10 protected from formation of ice (not shown) on the roof 12 of the trailer 14. The trailer 14 may be for example a conventional road going freight trailer which is drawn by a tractor 16. The tractor 16 may be of generally conventional type having a drive train (not separately shown) which is disposed to propel the tractor 16 along a roadway (not shown). The drive train will be understood to comprise an internal combustion engine including an exhaust system, which in turn further comprises an exhaust conduit 19 for discharging engine exhaust to the atmosphere. The trailer 14 may be of the type which is selectively coupled to the tractor 16 for draft transport and decoupled from the tractor 16. The above description summarizes certain components of typical conventional truck and tractor combinations.

The tractor and trailer combination 10 is improved by incorporation of a system for heating the roof 12 of the trailer 12 so as to oppose accumulation of ice and snow on the roof 12. Any snow or ice falling or forming on the roof 12 may be discharged from the roof 12 as water (not shown) after melting. The system for heating the roof 12 may comprise a first heat exchanger 18 disposed to provide heat to the roof 12 of the trailer 14 and an associated second heat exchanger 20 disposed to obtain waste heat from the internal combustion engine.

The first heat exchanger 18 may take any convenient form. In an unillustrated example, the first heat exchanger 18 may comprise a grid or other generally flat or planar layout of tubing such as plastic tubing, covered by an aluminum plate or plates. The aluminum plates may serve both to protect the plastic tubing and also to conduct heat from the plastic tubing to the entire area of the roof 12 of the trailer 14.

The first heat exchanger 18 and the second heat exchanger 20 are connected to one another by a fluid circulation circuit comprising a working fluid contained therein. The working fluid, which may be a mixture of water and conventional engine antifreeze product such as those comprising polyethylene or polypropylene glycol, and which are commercially available to the general public, is, disposed to obtain heat from the second heat exchanger 20 and deliver the heat to the first heat exchanger 18.

To this end, the fluid circulation circuit will be understood to comprise a fluid conduit 22 forming a closed loop extending between the first heat exchanger 18 and the second heat exchanger 20. The fluid conduit 22 will be understood to include all necessary apparatus to achieve operation as described, for example, including both supply and return legs, drain valves, and connectors including stationary connectors mounted to the trailer so that the fluid circulation circuit may be formed from separate sections of tubing (none of these is specifically shown). Referring also to FIG. 3, a pump 24 which is disposed serially within the closed loop of the fluid circulation circuit is disposed to pump the working fluid throughout the fluid conduit. Description of the fluid circulation circuit as forming a closed loop signifies that the fluid conduit 22 and fluid passages formed in the first heat exchanger 18 and the second heat exchanger 20 cooperate to provide an endless, repeating flow path so that the working fluid flows through repeating heat gain and heat loss cycles, and is not lost from the fluid circulation circuit. An expansion feature (not shown) may be provided to accommodate variation in fluid volume with changing temperatures, but would be incidental to operation for moving heat as described herein.

Referring also to FIG. 4, the system for heating the roof 12 comprises an electrical system disposed to operate the pump 24. The electrical system may comprise an electric motor 26 disposed to drive the pump 24 in any suitable way, a battery 28 disposed to provide operating power to the electric motor 26, conductors 30 forming a circuit enabling operation of the pump 24 using power from the battery 28, and a switch 32 which is disposed to open and close the circuit of the electrical system to initiate and stop operation of the pump 24. The conductors 30 will be understood to include ancillary apparatus such as connectors, circuit protective devices such as fuses, fuse clips, circuit breakers, indicating lights, and others (none shown) deemed advisable to provide in light of accepted practice in vehicular electrical systems, even if not explicitly described.

The switch 32 is shown in representative capacity only. The switch 32 may comprise a manual switch located at the trailer 14 or in the tractor 16. The switch may comprise a single device such as a pushbutton or a knife-blade switch, or may comprise a wireless link and remotely operated switching elements. For example, it would be possible to locate a manually operated wireless signal transmitter in the tractor 16 in a location convenient to a driver, with a corresponding signal responsive relay located at the trailer 14, such that the actual switching function is remotely actuated (this option is not shown).

In one implementation of the invention, the pump 24 and its motor 26, and the battery 28 are carried on the trailer 14. More specifically, the pump 24, the motor 26, and the battery 28 may be housed within a weather resistant enclosure 33 disposed on the trailer 14, at a front wall 34 thereof for example. The weather resistant enclosure 33 may have hinged doors 35A, 35B affording access to internal components, as described hereinafter. Of course, liquid handling apparatus such as connectors, drain valves, and manifolds may be provided within the weather resistant enclosure 33, as seen in a representative exemplary layout of FIG. 7. Manifolds, where provided, may be employed to divide flow from a singular tube or conduit into branches, such as to enable parallel fluid subcircuits to distribute heat to the roof 12 if desired, rather than having the fluid circulation circuits occur as a single undivided loop (parallel fluid subcircuits are not shown).

In a currently preferred implementation of the invention, the first heat exchanger 18, the pump 24, and the battery 28 are carried on the trailer, with the second heat exchanger 20 carried on the tractor 16, wherein the second heat exchanger 20 is coupled to the exhaust conduit 19 of the exhaust system of the internal combustion system of the tractor 16.

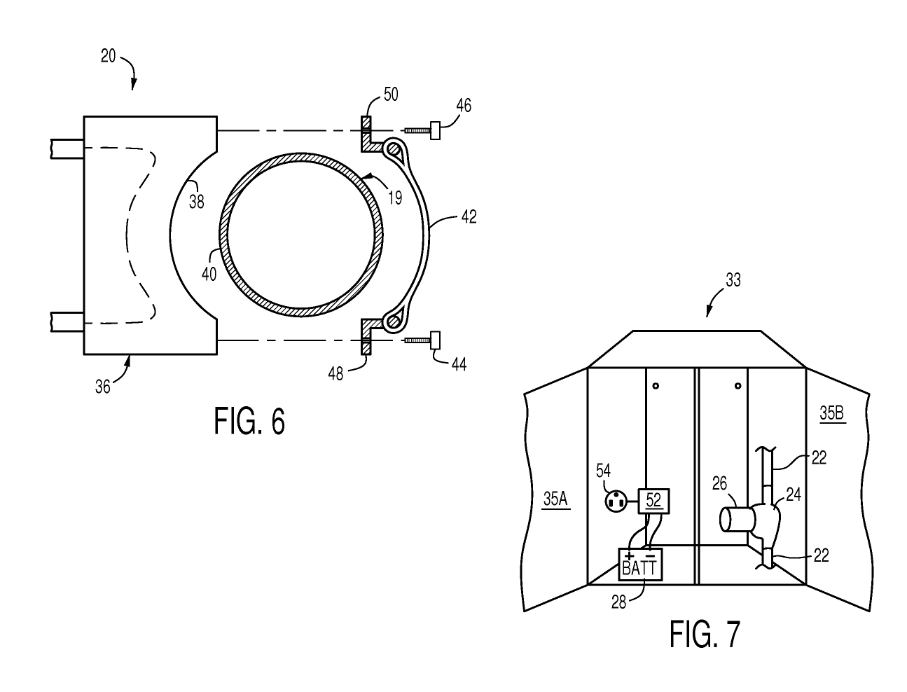

The second heat exchanger 20 may be readily installable on and readily removable from the exhaust conduit 19 of the exhaust system of the internal combustion engine. Description of the second heat exchanger 20 as being readily installable on and readily removable from signifies that installation and removal may be accomplished by hand or using only hand tools (not shown). For example, and referring momentarily to FIG. 6, the body 36 of the heat exchanger 20 may comprise an arcuate member or arcuate surface 38 which is dimensioned and configured to fit in close cooperation with a corresponding outer surface 40 of the exhaust conduit 19 of the exhaust system of the internal combustion engine. The heat exchanger 20 may comprise a coupling strap 42 which together with the second heat exchanger 20 encircles the exhaust conduit 19 of the exhaust system of the internal combustion engine, and clamps the second heat exchanger 20 to the exhaust conduit 19 of the exhaust system of the internal combustion engine.

The strap 42 may be secured in place by passing screws 44, 46 through respective brackets 48, 50 which engage the ends of the strap 42, and by threading the screws 44, 46 to threaded holes (not shown) formed in the body 36 of the second heat exchanger 20. Removal may be performed in reverse order of installation. If installation and removal can be done using screwdrivers, hand wrenches, or other manual tools, then the heat exchanger 20 may be said to be readily installed on and removed from the exhaust conduit 19.

The fluid circulation circuit described above is a dedicated circuit supplying only the first heat exchanger 18 with heat. It would be possible to modify the fluid circulation circuit such that other purposes are provided with heat. For example, the interior of the trailer 14 could be fully or partially heated using the fluid circulation circuit (this option is not shown).

Not only does the fluid circulation circuit obtain waste heat from the internal combustion engine of the tractor 16, notably from the exhaust system, but heat supplied to the working fluid is obtained exclusively from the exhaust system of the internal combustion system. If desired, the exhaust could be supplemented by other waste heat sources. Illustratively, engine coolant, engine lubricant, and transmission fluid could be used as sources of otherwise wasted heat (these options are not shown).

Because the tractor and trailer combination 10 includes a pivot joint, for example, as provided by the fifth wheel, that portion of the fluid circulation circuit connected directly to the second heat exchanger 20 may comprise flexible conduits. Thus, relative motion between the tractor 16 and the trailer 16, such as steering but also bumps and other vertical road displacements, are accommodated by the fluid circulation circuit without destructive consequences which might arise from the use of rigid fluid conduits. With the weather resistant enclosure 33 located on the front wall 34s of the trailer 14, the legs of the fluid circulation circuit extending to the heat exchanger 20, which are preferably flexible, may be conveniently limited in length.

Turning now to FIG. 5, the electrical system, such as that shown in FIG. 4, may comprise a battery recharging arrangement disposed to enable recharging of the battery 28. Although power may be obtained entirely or in part from the DC electrical system of the tractor 16 if desired, the battery recharging arrangement may comprise a power converter 52 disposed to enable recharging the battery 28 from an alternating current source. AC power is typically readily available at truck stop facilities (not shown). Hence the electrical system may comprise a power port 54 which is configured to be matingly compatible with 120V AC power plugs or other connectors. The power converter 52 and the power port 54 may be disposed within the weather resistant enclosure 33, as shown in FIG. 7.

Thus far, description of the invention has been set forth in terms of trailers drawn by tractors, such as the tractor and trailer combination 10. However, the principles of the invention may have further ranging applications. The novel system for opposing formation of ice on the roof may apply to vehicles other than trailers. Any large wheeled vehicle which is ultimately propelled by an internal combustion engine may enjoy the benefits of the present invention. For example, trucks having cabs and large bodies on a single unarticulated chassis, busses, and still other vehicles may incorporate a system according to the present invention. As employed herein, ultimate propulsion signifies that the wheeled vehicle the roof of which is protected from ice according to the invention may carry thereaboard its own internal combustion engine, or may be a draft vehicle such that the internal combustion engine providing propulsive power is carried aboard a tow vehicle.

According to one aspect, the invention may be regarded a system for opposing formation of ice on the roof of a wheeled vehicle such as the trailer 14. Such a system may be considered to comprise a first heat exchanger such as the heat exchanger 18 disposed to provide heat to the roof of the protected vehicle, a second heat exchanger such as the heat exchanger 20, if disposed to obtain waste heat from the internal combustion engine, a fluid circulation circuit such as the fluid circulation circuit comprising the fluid conduit 22, with or without a working fluid present, a pump disposed to pump working fluid throughout the fluid conduit, and an electrical system such as that described hereinabove, including a battery disposed to provide operating power to the pump, and a switch disposed to open and close the circuit to initiate and stop operation of the pump.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. A tractor and trailer combination protected from formation of ice on the roof of the trailer, comprising:
a tractor having a drive train disposed to propel the tractor along a roadway, wherein the drive train comprises an internal combustion engine having an exhaust system which in turn further comprises an exhaust conduit for discharging engine exhaust to the atmosphere;
a trailer disposed to be selectively coupled to the tractor for draft transport and decoupled from the tractor, having a roof; and
a system for heating the roof of the trailer so as to oppose accumulation of ice and snow on the roof, comprising:
a first heat exchanger disposed to provide heat to the roof of the trailer;
a second heat exchanger disposed to obtain waste heat from the internal combustion engine;
a fluid circulation circuit comprising a working fluid contained therein, disposed to obtain heat from the second heat exchanger and deliver the heat to the first heat exchanger, comprising a fluid conduit forming a closed loop extending between the first heat exchanger and the second heat exchanger, and a pump disposed to pump the working fluid throughout the fluid conduit; and
an electrical system disposed to operate the pump, comprising an electric motor disposed to drive the pump, a battery disposed to provide operating power to the electric motor, conductors forming a circuit enabling operation of the pump using power from the battery, and a switch disposed to open and close the circuit to initiate and stop operation of the pump, wherein
the pump and the battery are carried on the trailer, the second heat exchanger is carried on the tractor,
the second heat exchanger is coupled to an exhaust conduit of the exhaust system of the internal combustion system, and
that portion of the fluid circulation circuit connected directly to the second heat exchanger comprises flexible conduits, whereby relative motion between the tractor and the trailer is accommodated by the fluid circulation circuit.

2. The tractor and trailer combination of claim 1, wherein the fluid circulation circuit is a dedicated circuit supplying only the first heat exchanger with heat.

3. The tractor and trailer combination of claim 1, wherein that portion of the fluid circulation circuit connected directly to the second heat exchanger comprises flexible conduits, whereby relative motion between the tractor and the trailer is accommodated by the fluid circulation circuit.

4. The tractor and trailer combination of claim 1, wherein the second heat exchanger is readily installable on and readily removable from the exhaust conduit of the exhaust system of the internal combustion engine.

5. The tractor and trailer combination of claim 4, wherein the second heat exchanger comprises an arcuate member which is dimensioned and configured to fit in close cooperation with the exhaust conduit of the exhaust system of the internal combustion engine.

6. The tractor and trailer combination of claim 4, further comprising a coupling strap which together with the second heat exchanger encircles the exhaust conduit of the exhaust system of the internal combustion engine and clamps the second heat exchanger to the exhaust conduit of the exhaust system of the internal combustion engine.

7. The tractor and trailer combination of claim 1, further comprising a weather resistant enclosure disposed on the trailer, and wherein the battery and the electric motor of the pump are housed within the weather resistant enclosure.

8. The tractor and trailer combination of claim 1, further comprising a battery recharging arrangement disposed to enable recharging of the battery.

9. The tractor and trailer combination of claim 8, wherein the battery recharging arrangement comprises a power converter disposed to enable recharging the battery from an alternating current source.

10. The tractor and trailer combination of claim 7, further comprising a battery recharging arrangement disposed to enable recharging of the battery, which further comprises a power converter disposed to enable recharging the battery from an alternating current source, wherein the power converter is disposed within the weather resistant enclosure.

11. A system for opposing formation of ice on the roof of a large wheeled vehicle which is ultimately propelled by an internal combustion engine, comprising:
a first heat exchanger disposed to provide heat to the roof of the trailer;
a second heat exchanger disposed to obtain waste heat from the internal combustion engine;
a fluid circulation circuit comprising a working fluid contained therein, disposed to obtain heat from the second heat exchanger and deliver the heat to the first heat exchanger, comprising a fluid conduit forming a closed loop extending between the first heat exchanger and the second heat exchanger, and a pump disposed to pump the working fluid throughout the fluid conduit; and
an electrical system disposed to operate the pump, comprising an electric motor disposed to drive the pump, a battery disposed to provide operating power to the electric motor, conductors forming a circuit enabling operation of the pump using power from the battery, and a switch disposed to open and close the circuit to initiate and stop operation of the pump.

12. The system of claim 11, wherein the second heat exchanger is disposed to obtain heat from the exhaust system of the internal combustion engine.

13. The system of claim 12, wherein heat supplied to the working fluid is obtained exclusively from the exhaust system of the internal combustion system.

14. The system of claim 11, wherein that portion of the fluid circulation circuit connected directly to the second heat exchanger comprises flexible conduits.

15. The system of claim 11, wherein the second heat exchanger is readily installable on and readily removable from the exhaust conduit of the exhaust system of the internal combustion engine.

16. The system of claim 11, wherein the fluid circulation circuit is a dedicated circuit supplying only the first heat exchanger with heat.

17. The system of claim 15, wherein the second heat exchanger comprises an arcuate member which is dimensioned and configured to fit in close cooperation with the exhaust conduit of the exhaust system of the internal combustion engine.

18. The system of claim 17, further comprising a coupling strap which together with the second heat exchanger encircles the exhaust conduit of the exhaust system of the internal combustion engine and clamps the second heat exchanger to the exhaust conduit of the exhaust system of the internal combustion engine.

19. The system of claim 11, further comprising a weather resistant enclosure, and wherein the battery and the electric motor of the pump are housed within the weather resistant enclosure.

20. The system of claim 11, further comprising a battery recharging arrangement disposed to enable recharging of the battery.

21. The system of claim 11, wherein the battery recharging arrangement comprises a power converter disposed to enable recharging the battery from an alternating current source.

22. The system of claim 19, further comprising a battery recharging arrangement disposed to enable recharging of the battery, comprising a power converter disposed to enable recharging the battery from an alternating current source, wherein the power converter is disposed within the weather resistant enclosure.
